(19) United States
(12) Patent Application Publication
(10) Pub. No.: US 2009/0216654 A1
(43) Pub. Date: Aug. 27, 2009

(54) MUSICAL BOUQUET

(75) Inventor: Donald W. COWART, Arlington, TX (US)

Correspondence Address: CARSTENS & CAHOON, LLP, P O BOX 802334, DALLAS, TX, 75380, US

(73) Assignee: SPIRIT INTERNATIONAL, INC., Carrollton, TX (US)

(21) Appl. No.: 12/038,607

(22) Filed: Feb. 27, 2008

(51) Int. Cl. G06Q 30/00; G06F 17/00

(52) U.S. Cl. 705/26; 700/94

(57) ABSTRACT

The present invention relates to an apparatus and method for sending a bouquet of flowers to a recipient wherein the recipient can play back a customized audio or other media recording. In accordance with one embodiment of the present invention, the base of the vase is a molded plastic base having within it an MP3 player connected to a USB port connected to said base. The USB port may be connected to a computer or other source to download audio files to the MP3 player. The base additionally has one or more controls for controlling playback of the audio recordings. In one embodiment, the base includes an ON/OFF button and a PLAY button. The ON/OFF button is used to turn the MP3 player on and off. The PLAY button is used to start the audio recording. A battery may also be attached to the MP3 player to provide a power source so that the musical bouquet need not be plugged in to play back the audio files. A seller of the vase can download the audio files requested by a customer prior to delivering the vase to a recipient.

### BACKGROUND OF THE INVENTION

1. Technical Field

The present invention relates to a flower vase and, more particularly, to a method and system for distributing bouquets which have a customized message, songs or other media playable by a recipient of said vase.

2. Description of Related Art

It has been a known method of florists to provide the service of sending a bouquet of flowers in a vase with a personal written message from the sender to the recipient. Providing a personalized message provides a more enjoyable experience for the recipient of the flower arrangement. It has also been known for individuals to give a music tape or CD of songs selected by the giver to send to the recipient as a gesture of friendship or romance. To date, there has never been a method or system for distributing flowers in a vase along with customizable music or other audio message to the recipient. It would be desirable and attractive to have a system and method of distributing flowers in a vase containing customizable songs or other media on a player attached to said vase in an economical and efficient manner. Therefore, it is an object of the present invention to provide both a vase to which music or other audio can be easily downloaded and played back by the recipient of the vase. It is also an object of the present invention to provide a method for florists to accommodate a request for particular songs or audio or media to be downloaded to a vase and distributed to a recipient without requiring a personal appearance at the florist's place of business by the purchaser to make a recording or to give the florist the desired song or other media to be downloaded to the vase.

### SUMMARY OF THE INVENTION

The present invention relates to an apparatus and method for sending a bouquet of flowers to a recipient wherein the recipient can play back a customized audio or other media recording. In accordance with one embodiment of the present invention, the base of the vase is a molded plastic base having within it an MP3 player connected to a USB port connected to said base. The USB port may be connected to a computer or other source to download audio files to the MP3 player. The base additionally has one or more controls for controlling playback of the audio recordings. In one embodiment, the base includes an ON/OFF button and a PLAY button. The ON/OFF button is used to turn the MP3 player on and off. The PLAY button is used to start the audio recording. A battery may also be attached to the MP3 player to provide a power source so that the musical bouquet need not be plugged in to play back the audio files. A seller of the vase can download the audio files requested by a customer prior to delivering the vase to a recipient.

### BRIEF DESCRIPTION OF THE DRAWINGS

FIG. 1 is a perspective view of vase in accordance with an embodiment of the present invention.

FIG. 2 is a schematic diagram of an audio player in accordance with an embodiment of the invention.

### DETAILED DESCRIPTION OF THE INVENTION

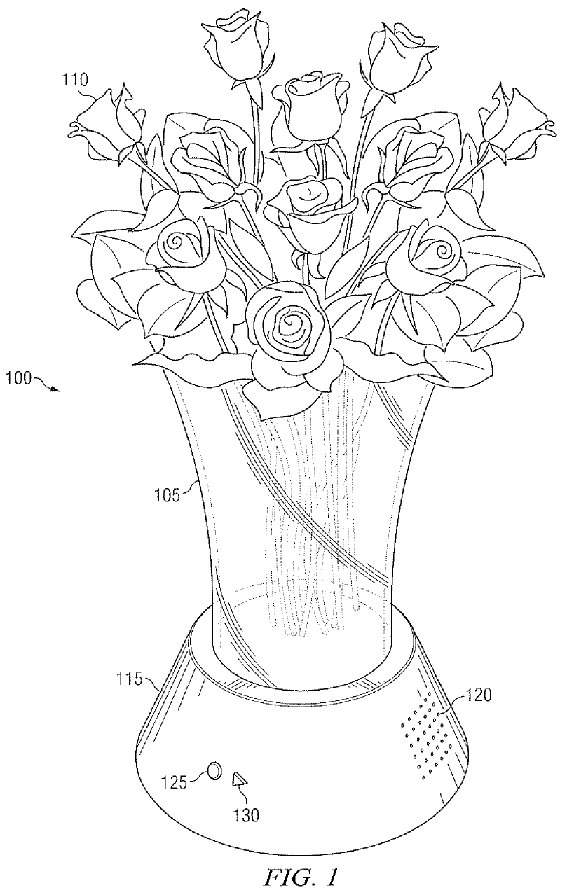

Referring now to FIG. 1, a perspective view of a vase in accordance with an embodiment of the invention is shown. The musical vase 100 has a vase 105 attached to a molded plastic base 115. The vase 105 can be constructed from materials known in the art, including glass or plastic. The base 115 can also be constructed of numerous materials as one with skill in the art would recognize. In one embodiment, the base is a molded plastic base. The base 115 contains a grill 120 having holes for a speaker output. Additionally, the base 115 contains a power button 125 and a play button 130. The vase 105 can contain flowers 110 of any kind.

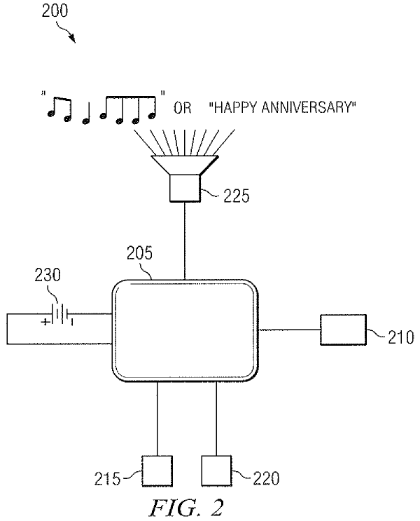

Referring now to FIG. 2, a schematic diagram of an audio player in accordance with an embodiment of the invention is shown. The audio player 200 contains an MP3 player. The player need not be an MP3 player but could be any music player capable of storing and playing back audio. The MP3 player 205 is attached to a USB port 210 which is attached to the molded base 115. The USB port 210 can be connected via a USB cable to a computer or other source from which audio files may be downloaded to the MP3 player 205. A power switch 215 is connected to the MP3 player 205 for turning the power to the MP3 player 205 on and off. A play switch 220 is connected to the MP3 player for playing the audio files stored on the MP3 player once the MP3 player is turned on. The MP3 player 205 also has a speaker output 225 attached. The speaker 225 is mounted inside the housing 115 adjacent to the speaker output 120.

To keep the cost of the vase down, the MP3 player 205 may be a simple player with memory capable of storing only a few songs. The musical vase 100 of the present invention can be used by florists to provide a competitive advantage over other florists. Because there are no florists who are combining a vase with an audio player, this will provide a distinct marketing advantage for florists who use the musical vase 100 in connection with selling flowers.

As an example of this method of doing business, the florist solicits via normal advertising channels purchases of the musical vase 100. The florist may advertise that certain songs can be selected by the purchaser for download to the MP3 player 205 located within the base 115 of the vase 105. Alternatively, the purchaser can email or otherwise transmit to the florist an audio file for download to the MP3 player 205 via the USB port 210. Then the florist can download the file from its computer onto the MP3 player 205. The florist can provide an online list of songs available for download to the MP3 player 205 and can charge the purchaser of the vase based on the number of songs the purchaser requested to be downloaded. Alternatively, the purchase price of the vase and flower arrangement can include the download of a certain number of songs or an audio file or both at the purchaser's request. For example, the florist can allow the purchaser to choose up to three songs and add up to three audio files such that the purchaser creates an audio file to be placed before each song or creates an audio file to be placed at the beginning of all of the songs. The florist then downloads the file in the order requested by the purchaser.

Although the present invention has been described in terms of an exemplary embodiment, it is not limited to these embodiments and modifications. Alternative embodiments, modifications, and equivalents, which would still be encompassed by the invention, may be made by those of ordinary skill in the art, in light of the foregoing teachings. Therefore, the following claims are intended to cover any alternative embodiments, modifications, or equivalents which may be included within the spirit and scope of the invention defined by the claims. For example, a volume control could also be added to the vase as is known in the art. The songs could be made to loop once the play button is pushed so that the player continually plays the same songs over and over again until the player is stopped by the user. Additionally, a videoplayer could be added to the vase such that the purchaser could request a video be downloaded for playback during the songs as well. The power source for the MP3 player 205 could be an external source such as a household electrical outlet and various connections other than USB can be utilized as is known in the art.

1. An apparatus for sending flowers and customized media, said apparatus comprising:
a vase for holding said flowers;
a base attached to said vase for supporting said vase;
a media player housed within said base for playing said customized media, wherein said media player comprises a memory for storing said customized media;
a port connected to said media player for allowing said customized media to be downloaded to said memory;
a media outlet connected to said media player wherein said media outlet is housed in said base; and
a switch connected to said media player for activating playback of said customized media to said media outlet.

2. The apparatus of claim 1 wherein said media player is a digital music player.

3. The apparatus of claim 2 wherein said media outlet comprises a speaker housed in a wall of said base.

4. The apparatus of claim 3 wherein said port comprises a USB port housed in said wall of said base.

5. The apparatus of claim 1 wherein said media player comprises a digital video player.

6. The apparatus of claim 4 wherein said media outlet comprises a video display housed in a wall of said base.

7. The apparatus of claim 6 wherein said port comprises a USB port housed in said wall of said base.

8. A method of sending flowers and customized media, said method comprising the steps:
a) downloading said customized media to an apparatus for sending flowers and customized media, said apparatus comprising: a vase for holding said flowers; a base attached to said vase for supporting said vase; a media player housed within said base for playing said customized media, wherein said media player comprises a memory for storing said customized media; a port connected to said media player for allowing said customized media to be downloaded to said memory; a media outlet connected to said media player wherein said media outlet is housed in said base; and a switch connected to said media player for activating playback of said customized media to said media outlet;
b) inserting said flowers into said vase; and
c) delivering said apparatus to a recipient.

9. The method of claim 8 wherein said step of downloading comprises obtaining a request from a purchaser regarding a content of said customized media and complying with said request.

10. The method of claim 9 wherein said customized media comprises at least one song.

11. The method of claim 9 wherein said customized media comprises at least one voice message.

12. The method of claim 9 wherein said customized media comprises at least one video.

13. The method of claim 8 wherein said customized media comprises at least one file obtained from a purchaser.

14. The method of claim 13 wherein said at least one file comprises a music file.

15. The method of claim 13 wherein said at least one file comprises a voice message file.

16. The method of claim 13 wherein said at least one file comprises a video file.
